(19) United States
(12) Patent Application Publication
(10) Pub. No.: US 2004/0235449 A1
(43) Pub. Date: Nov. 25, 2004

(54) Mobile communications network

(75) Inventor: Francis E. Noel JR., Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/443,484

(22) Filed: May 22, 2003

(51) Int. Cl. H04M 11/00

(52) U.S. Cl. 455/405; 455/406

(57) ABSTRACT

Wireless connectivity for data communication is extended to users who are in public transport vehicles such as airliners, corporate aircraft, autobuses, trains and the like. The access allowed is extended to enable communications between such transiting users and between such transiting users and geographically based networks.

### FIELD AND BACKGROUND OF INVENTION

The 802.11 standard is a family of specifications created by the Institute of Electrical and Electronics Engineers Inc. for wireless local area networks in the 2.4-gigahertz bandwidth space. 802.11 can be thought of as a way to connect computers and other gadgets to each other and to the Internet at very high speed without any cumbersome wiring—basically, a faster version of how a cordless phone links to its base station. With 802.11, electronic devices can talk to each other over distances of about 300 feet at 11 megabits a second, which is faster than some wired networks in corporate offices.

Devices using 802.11—increasingly known as Wi-Fi—are relatively inexpensive. A network hub, also known as an access point, can be bought inexpensively and will coordinate the communication of all 802.11 equipped devices within range and provide a link to the Internet and/or any intranet to which the access point is linked. The cards that let a laptop computer or other device “plug” into the network are also inexpensive. Some personal communication devices come enabled for 802.11 communications without the need of an additional card.

Providing so much wireless speed at a modest price is having profound implications for a world bent on anytime/anywhere communication. Wi-Fi is spreading rapidly. College students are setting up networks in their dorms and cafeterias. Folks in some parts of San Francisco are building 802.11 networks to cover their neighborhoods. Starbucks Corp., United Airlines Inc., and Holiday Inn, among others, are installing 802.11 networks in their shops, airport lounges, and hotels, in a nod toward their customers' desire to stay connected. It has been reported that, in 2000, the number of people using wireless local area networks rose by 150 percent, according to Synergy Research Group. Cahners In-Stat Group, a Scottsdale, Ariz.-based market research firm, sees the number of wireless data users in business growing from 6.6 million today to more than 39 million by 2006. Feeding this trend is the fact that almost a quarter of all workers in small or medium-sized business are mobile workers, spending at least 20 percent of their time away from the office. Wireless e-mail is their prime need, which is why mobile computing products with always-on e-mail capability continue to sell so well. In early 2002, it was estimated that between 25,000 and 50,000 people install and manage 802.11 networks every day.

Successor technologies to 802.11 are on the horizon. One is ultra-wide band radio technology or UWB, which uses a wide spectrum at low power to transfer data at a very high speed. UWB will be perhaps ten times faster than 802.11, yet suffer from some of the same needs described here. Another is the inclusion of radio frequency function directly on chips which perform other functions such as system central processors.

While the proliferation of 801.11 functionality has addressed issues of mobility with a geographically based network, there are issues left unaddressed. A geographically based network, as used in this description, is a data communications network formed by wired and wireless access points provided across and within a geographical area at fixed locations. A use of the data communications capabilities provided by the network may access those capabilities either by a wired connection at a fixed location or by establishing a wireless connection to a wireless access point which is at a fixed location. This mobility is enabled for users within the restraints imposed by the geographically based network. Within those restraints, a user may have mobility as allowed by the wireless capabilities of the user's system and the access points.

Such capabilities have not, however, extended to users who may be in transit. That is, a user going from one geographic area to another using transit services such as an autobus, airplane, train or the like will be out of communication during the necessary transit interval. This presents a disadvantage to some users. Further, where a group of business people are traveling together, the absence of connectivity during a transit interval detracts from possible useful group work.

### SUMMARY OF THE INVENTION

With the foregoing in mind, it is a purpose of this invention to open communication during a transit interval as described above. In particular, the present invention contemplates that wireless connectivity be extended to users who are in public transport vehicles such as airliners, corporate aircraft, autobuses, trains and the like. Further, the present invention contemplates that the access allowed be extended to enable communications between such transiting users and between such transiting users and geographically based networks as described before.

In realizing these purposes, the present invention provides a wireless access point in a public transport vehicle and a data communication connection between that access point and more conventional geographically based networks.

### BRIEF DESCRIPTION OF DRAWINGS

Some of the purposes of the invention having been stated, others will appear as the description proceeds, when taken in connection with the accompanying drawings, in which:

FIG. 1 is a schematic representation of a public transport vehicle in which the present invention is implemented;

FIG. 2 is a schematic representation of a flow chart illustrating the implementation of this invention.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

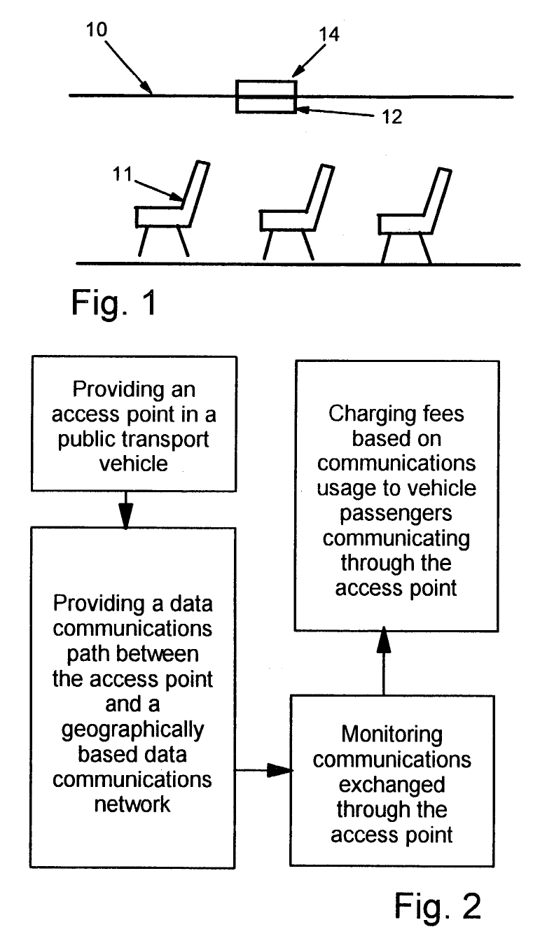

Referring now more particularly to the accompanying drawings, FIG. 1 depicts a schematic view of the interior of a transport vehicle 10 for passengers, as indicated by the presence of a plurality of seats 11 for such passengers. The vehicle, in accordance with this invention, may be any vehicle for mass transport of people, such as an airplane, train, autobus, ferry or the like.

In order to enable communication through a network capable of linking passengers one to another and to network resources outside the vehicle, the vehicle is provided with a wireless data communications access point 12. The access point 12 may be mounted within the vehicle 10 in any convenient manner and in any convenient location so long as the capability of linking passengers is maintained. As illustrated, the access point 12 is mounted in or adjacent the overhead or ceiling of the passenger compartment. The access point may be mounted in an convenient location from which effective communication may be maintained, and need not be visible to passengers.

The access point is coupled with a data link which is effective to couple the access point to a geographically based communications network; with a usage monitor which detects usage of data communication through the access point by a vehicle passenger; and with a usage fee calculator coupled to the monitor which calculates a fee to be charged to the vehicle passenger for usage of the access point. In FIG. 1, the data link, monitor and calculator are housed in a housing 14 which is adjacent to the access point and shown as outside the overhead. As will be understood by person of skill in the applicable arts of networking, the data link, monitor and calculator may be housed together or separately, within the access point or separately therefrom as shown, and in various other ways. What is significant is that a data communication link is provided from the moving vehicle to a data communications network which is more fixed in location. The monitor and calculator may be implemented through a conventional processor executing appropriate instructions to sense and record usage by passengers of the facilities provided by this invention. It is contemplated that passengers linking to the access point will be able to form ad hoc networks between or among passengers as well as communicate to the world outside the bounds of the vehicle through the data link. The service provider implementing the mobile access capability will be able to identify using passengers and charge for such usage in an appropriate manner based on data flow, bandwidth use, time, or other factors determined by the service providers business plan.

FIG. 2 illustrates, in flow chart form, the method of providing the service here described. The method has the steps of enabling data communication by providing a wireless data communications access point in a public transport vehicle; enabling data communication by providing a data communications path between the access point and a geographically based data communications network; monitoring communications exchanged through the access point; and charging fees based on communications usage to vehicle passengers communicating through the access point. The step of monitoring may include monitoring communications exchanged between or among passengers and between a passenger and the geographically based network to which the access point is linked. The public transport vehicle may be any transport vehicle capable of transporting passengers, including, but not limited to, an airplane, a boat or watercraft, a train, and a motorbus.

In the drawings and specifications there has been set forth a preferred embodiment of the invention and, although specific terms are used, the description thus given uses terminology in a generic and descriptive sense only and not for purposes of limitation.

What is claimed is:

1. A method comprising the steps of:
enabling data communication by providing a wireless data communications access point in a public transport vehicle;
enabling data communication by providing a data communications path between the access point and a geographically based data communications network;
monitoring communications exchanged through the access point; and
charging fees based on communications usage to vehicle passengers communicating through the access point.

2. A method according to claim 1 wherein the step of monitoring comprises monitoring communications exchanged between vehicle passengers.

3. A method according to claim 1 wherein the step of monitoring comprises monitoring communications exchanged between a vehicle passenger and the geographically based communications network.

4. A method according to claim 3 wherein the step of monitoring further comprises monitoring communications exchanged between vehicle passengers.

5. A method according to claim 1 wherein the step of enabling wireless data communication comprises mounting an access point in a motor bus.

6. A method according to claim 1 wherein the step of enabling wireless data communication comprises mounting an access point in an airplane.

7. A method according to claim 1 wherein the step of enabling wireless data communication comprises mounting an access point in a watercraft.

8. A method according to claim 1 wherein the step of enabling wireless data communication comprises mounting an access point in a train.

9. Apparatus comprising:
a public transport vehicle;
a wireless access point in said vehicle and enabling data communication with vehicle passengers;
a data link effective to couple said access point to a geographically based communications network;
a usage monitor coupled to said access point which detects usage of data communication through said access point by a vehicle passenger; and
a usage fee calculator coupled to said monitor which calculates a fee to be charged to the vehicle passenger for usage of the access point.

10. Apparatus according to claim 9 wherein said public transport vehicle is a motor bus.

11. Apparatus according to claim 9 wherein said public transport vehicle is an airplane.

12. Apparatus according to claim 9 wherein said public transport vehicle is a watercraft.

13. Apparatus according to claim 9 wherein said public transport vehicle is a train.

14. Apparatus according to claim 9 wherein said usage monitor comprises circuitry which monitors communications exchanged between vehicle passengers.

15. Apparatus according to claim 9 wherein said usage monitor comprises circuitry which monitors communications exchanged between a vehicle passenger and the geographically based communications network.

16. Apparatus according to claim 15 wherein said usage monitor further comprises circuitry which monitors communications exchanged between vehicle passengers.
